(19) United States
(12) Patent Application Publication
(10) Pub. No.: US 2007/0232309 A1
(43) Pub. Date: Oct. 4, 2007

(54) Wireless terminals and methods employing diverse reception path measurements in transmission gaps

(76) Inventor: Christopher Koszarsky, Holly Springs, NC (US)

Correspondence Address: MYERS BIGEL SIBLEY & SAJOVEC, P.A., P.O. BOX 37428, RALEIGH, NC, 27627, US

(21) Appl. No.: 11/395,269

(22) Filed: Mar. 31, 2006

(51) Int. Cl. H04Q 7/20

(52) U.S. Cl. 455/436

(57) ABSTRACT

A communications session, e.g., a call, is established between the wireless terminal and a base station. Reception of at least one channel over respective diverse reception paths in the wireless terminal is measured during at least one transmission gap in the communications session. The at least one transmission gap may include, for example, a handover candidate channel evaluation transmission gap and/or an interfrequency measurement gap. Measurement of the selection diverse reception paths may be preceded by transitioning to a compressed mode of communications between the base station and the terminal, and the at least one transmission gap may include a transmission gap associated with the compressed mode.

### BACKGROUND OF THE INVENTION

The present invention relates to mobile terminals and, more particularly, to reception in wireless terminals having diverse reception paths, e.g., spatially diverse antennas.

Wireless terminals are now widely used for a variety of different types of communications. For example, cellular telephone systems are now ubiquitous, while cellular and other networks are increasingly being used to support more data-intensive applications, such as electronic mail, internet access, media distribution, and the like. The expansion of so-called 3G and higher order wireless systems will likely bring about a need to further increase data throughput. Improving the reception capabilities of wireless terminals may generally increase throughput.

Diversity techniques are commonly used to improve reception. In a typical receive diversity (or “diversity combining”) approach, wireless terminal reception may be improved by increasing the number of receiver channels used to receive a given traffic channel. In a typical implementation, respective receivers are connected to respective spatially (or otherwise) diverse antennas. The spacing of the antennas may be such that there is a relatively high probability that at least one of the antennas will have favorable reception. Signals produced from the respective receivers may be weightedly combined in a number of different ways to achieve optimal reception.

Advantages of such an approach may include better data throughput, improved reception in fringe coverage areas, and more consistent data transfer rates. However, implementation of receive diversity may be challenging in a mobile device, such as a cellular handset, as the multiple receiver structures may be relatively costly and complex, may have relatively high computational burdens, and may consume relatively large amounts of power.

Another known diversity technique is a more limited selection diversity approach implemented at the antenna level. In a wireless terminal, for example, two or more antennas and a single receiver may be provided, with the receiver being switchable between the antennas based on channel quality or other some other figure of merit. Advantages of such an approach may include use of fewer components and relatively simplified control. However, such an approach may not deliver the same level of performance that can be achieved with full receive diversity.

A problematic issue for some conventional selection diversity implementations is the decision criteria used to switch the receiver among the antenna paths. For example, a blind switch from one antenna to another may have undesirable effects, such as interruption of a communications session (e.g., a dropped call). Accordingly, there is a need for improved techniques for diversity reception.

### SUMMARY OF THE INVENTION

Some embodiments of the present invention provide methods of operating a wireless terminal. A communications session, e.g., a call, is established between the wireless terminal and a base station. Reception of at least one channel over respective diverse reception paths in the wireless terminal is measured during at least one transmission gap in the communications session. The at least one transmission gap may include, for example, a handover candidate channel evaluation transmission gap and/or an interfrequency measurement gap. Measurement of the selection diverse reception paths may be preceded by transitioning to a compressed mode of communications between the base station and the terminal, and the at least one transmission gap may include a transmission gap associated with the compressed mode.

The selection diverse reception paths may include first and second antennas of the wireless terminal. One of the first and second antennas may be selected for communications of the wireless terminal responsive to measuring reception via the first and second antennas of the wireless terminal.

According to further embodiments of the present invention, measuring reception via first and second antennas of the wireless terminal may include measuring reception via the first and second antennas for a plurality of candidate channels. The measurements of the candidate channels may be reported to the base station, for example, to assist in handover operations. The base station may identify the plurality of candidate channels to the wireless terminal before performance of the measurements.

According to further embodiments of the present invention, a wireless terminal includes a radio reception system configured to provide selection diverse first and second reception paths in the wireless terminal. The terminal further includes a controller operatively associated with the reception system and configured to measure reception of one or more channels over the respective first and second selection diverse reception paths during at least one transmission gap in a communications session between the wireless terminal and a base station. The at least one transmission gap may include a handover candidate channel evaluation transmission gap and/or an interfrequency measurement gap. The at least one transmission gap may include a transmission gap associated with a compressed mode of communications.

The reception system may include first and second spatially separate antennas and a receiver configured to selectively receive signals via the first and second antennas. The controller may be configured to measure reception via the first and second antennas during the at least one transmission gap. The controller may be further configured to select one of the first and second antennas for communications of the wireless terminal responsive to measuring reception via the first and second antennas of the wireless terminal.

Further embodiments of the present invention provide computer program products for controlling a wireless terminal. A computer program product includes computer program code embodied in a storage medium, the computer program code including program code configured to establish a communications session between the wireless terminal and a base station and to measure reception of at least one channel over respective selection diverse reception paths in the wireless terminal during at least one transmission gap in the communications session. The selection diverse reception paths may include first and second antennas of the wireless terminal, and the computer program code may further include program code configured to select one of the first and second antennas for communications of the wireless terminal responsive to measuring reception via the first and second antennas of the wireless terminal.

### BRIEF DESCRIPTION OF THE DRAWINGS

FIG. 1 is a schematic block diagram of a mobile terminal according to some embodiments of the present invention.

FIGS. 2 and 3 are flowcharts illustrating reception path evaluation operations according to various embodiments of the present invention.

FIGS. 4 and 5a-5c illustrate transmission gaps in a compressed communications mode that may be used for reception path evaluation according to some embodiments of the present invention.

FIGS. 6 and 7 are flowcharts illustrating reception path evaluation operations according to further embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention described herein relate to evaluating selection diverse reception paths in a wireless terminal. As used herein, “selection diverse reception paths” in a wireless terminal include, but are not limited to, selection diverse antennas and/or other receiving circuitry of the terminal by which radio communications may be selectively received by the terminal. Selection diverse reception paths may also include, for example, selectable (e.g., alternative) receive circuitry, such as alternative signal filtering and processing chains. As used herein, “wireless terminal” includes any portable electronic device configured to act as a terminal in a wireless communications system and may include, but is not limited to, cellular handsets, as well as PDAs, notebook computers, media player devices and other personal electronic devices with wireless communications capabilities.

Some embodiments of the present invention stem from a realization that selection diversity may be improved by using transmission gaps in communications sessions to evaluate selection diverse reception paths, e.g., selection diverse antenna feeds and/or selection diverse receive chains, in a wireless terminal. In some embodiments, such transmission gaps may be gaps that are provided for channel measurement, such as those provided in certain compressed modes of communications. For example, 3GPP/UMTS specifications include compressed modes that provide transmission gaps that may be used for interfrequency channel measurements that support handover operations and, in some embodiments of the present invention, such gaps may be also used to perform evaluative measurements of diverse antenna paths. The antenna measurements may be performed in conjunction with channel measurements that are used in the handover operations.

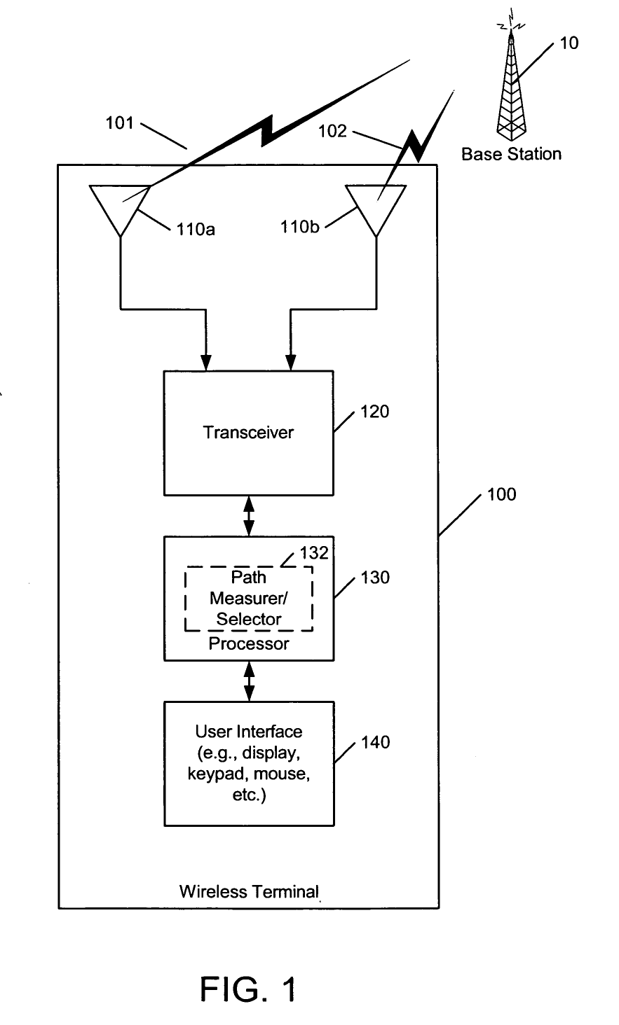

FIG. 1 illustrates a wireless terminal 100 according to some embodiments of the present invention. The terminal 100 may be, for example, a mobile terminal, such as a cellular handset or a portable electronic device, such as a PDA or laptop computer, enabled for cellular wireless communications. The terminal 100 includes a transceiver 120 and a user interface 140 (e.g., displace, keypad, mouse or the like), which are operatively associated with a controller, here shown as a processor 130. The transceiver 120 is configured to selectively receive radio signals 101, 102 via spatially separated first and second antennas 110a, 110b, thus providing a reception system with selection diverse first and second reception paths.

In some embodiments, the antennas 110a, 110b may be separated by a distance, e.g., a distance approximately equivalent to a wavelength of signals received by the terminal 100, and the transceiver 120, under control of the processor 130, may be configured to select which of the antennas 110a, 110b may be favorably used for communications of the terminal. It will be understood that, although FIG. 1 illustrates the use of two spatially diverse antennas, further embodiments of the present invention may use more than two spatially diverse antennas, or may use antennas having other types of diversity, such as polarization diversity.

The transceiver 120, under control of the processor 130, may switch between receiving signals via the first antenna 110a and receiving signals via the second antenna 110b based on reception measurements of the respective reception paths associated therewith. For example, as illustrated in FIG. 1, a path measurer/selector application 132 may execute on the processor 130 (and associated memory thereof). The application 132 may measure signals received via the respective antennas 110a, 110b and may, responsive to the measurements, select one of the antennas 110a, 110b for further communications of the terminal 100. In some embodiments of the present invention described below, for example, the measurements may be made during a transmission gap in a communications session between the terminal 100 and a base station 10. The transmission gap may comprise, for example, a protocol-specified gap that is conventionally used for handover candidate channel evaluations, such as a transmission gap specified in a compressed mode under 3GPP/UMTS specifications.

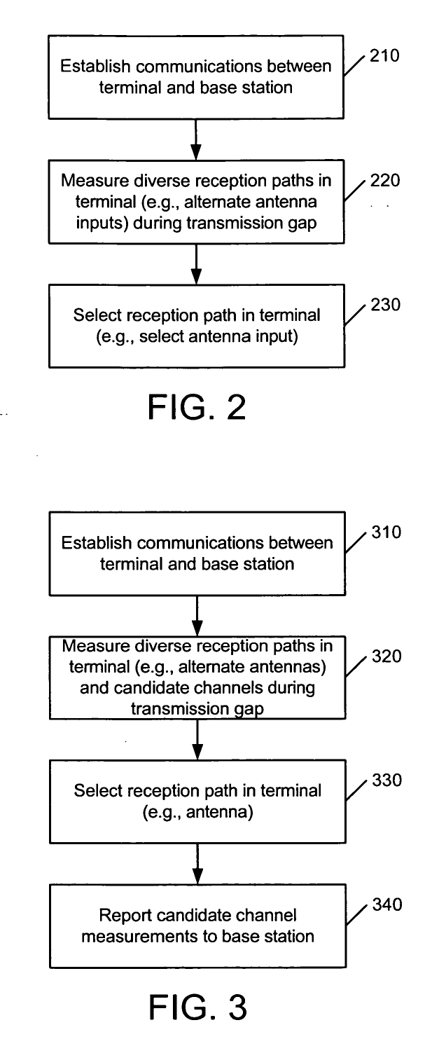

FIG. 2 illustrates exemplary operations for reception path evaluation and selection in a wireless terminal, such as the wireless terminal 100, according to further embodiments of the present invention. Communications are established between the wireless terminal 100 and a base station 10 (block 210). Selection diverse reception paths (e.g., paths including the respective antennas 110a, 110b) in the wireless terminal 100 are measured during a transmission gap in a communications session (e.g., a telephone call) between the terminal 100 and the base station 10 (block 220). Responsive to the measurements, a reception path in the terminal is selected (block 230).

According to further embodiments of the present invention, evaluation of reception paths in a wireless terminal may be combined with candidate channel evaluation operations that are used, for example, for handover purposes. FIG. 3 illustrates examples of such combined operations according to further embodiments of the present invention. Communications (e.g., a call) are established between the wireless terminal 100 and a base station (block 310). During a transmission gap in a communications session, selection diverse reception paths and candidate channels, e.g., an interfrequency handover candidate channel search list, are measured (block 320). For example, during these evaluation operations, different combinations of handover candidate channels and reception paths may be evaluated. Based on the measurements, a reception path may be selected (block 330) and candidate channel measurements may be reported to the base station, e.g., using transmit capabilities of the transceiver 120 (block 340).

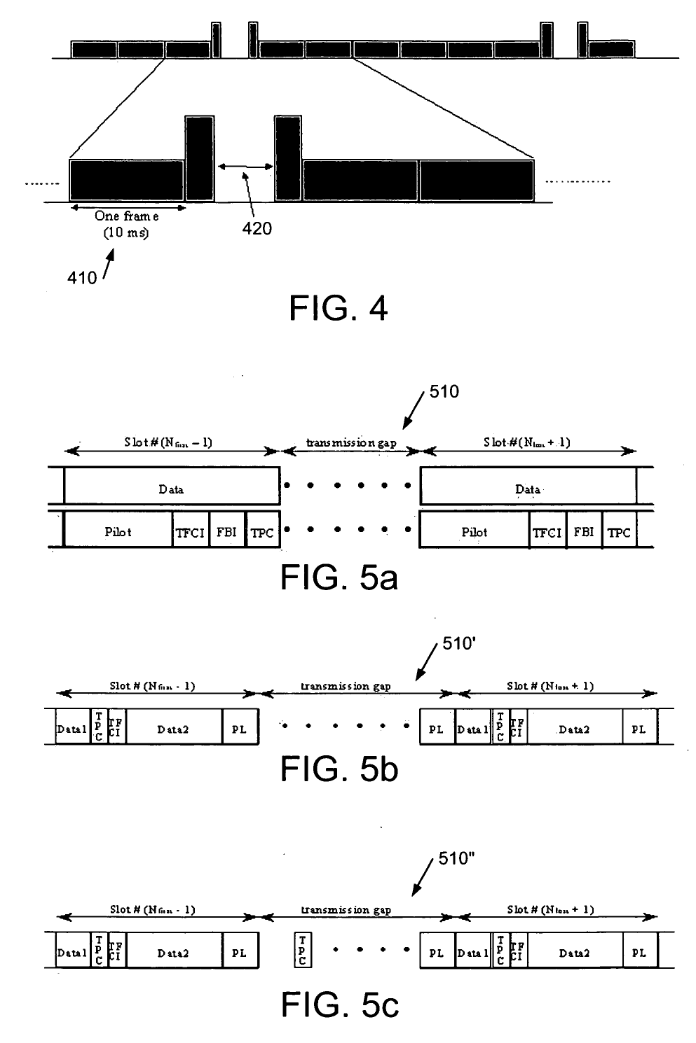

FIGS. 4 and 5a-5c illustrate exemplary transmission gaps that may be used for reception path evaluation according to some embodiments of the present invention. Referring to FIG. 4, a transmission gap 420 may be provided in compressed mode communications under the 3GPP/UMTS Specification TS 25.212. In some embodiments of the present invention, during interfrequency handover, a wireless terminal may use one or more of such transmission gaps to make measurements on different candidate carrier frequencies for respective selection diverse reception paths, e.g., selection diverse antennas. For example, 1-7 slots may be used for these operations. The slots can be in the middle of a single frame 410 and/or spread over two frames. Compressed frames can occur periodically or may be requested. The rate and type of compressed frames generally depends on environment and measurement requirements. FIG. 5a illustrates an uplink compressed frame structure with a transmission gap 510, while FIGS. 5b and 5c illustrate two different formats for downlink compressed frames with transmission gaps 510′ and 510.″

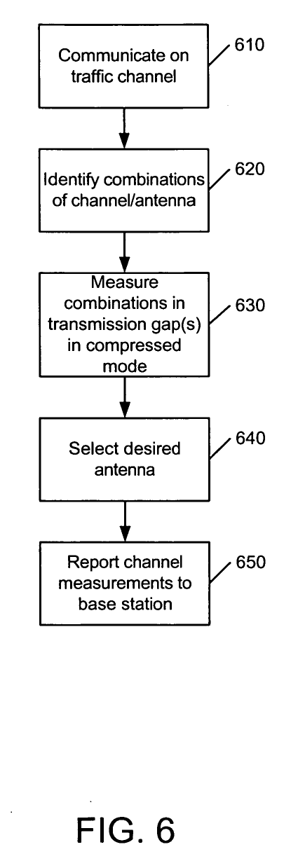

FIG. 6 illustrates exemplary operations according to further embodiments of the present invention, in which antenna evaluation and channel measurements may be performed in concert in one or more transmission gaps of compressed mode communications, such as those shown in FIGS. 4 and 5a-5c. A wireless terminal having a plurality of selection diverse antenna paths communicates with a base station on a traffic channel (block 610). The terminal identifies a plurality of combinations of antennas and channels to be measured (block 620). For example, the channels may be candidate channels identified to the terminal by the base station as part of handover operations. The terminal measures the various antenna/channel combinations in one or more transmission gaps in a compressed mode (block 630). Responsive to the measurements, the terminal selects a desired antenna (block 640), and reports the channel measurements (e.g., channel measurements using the desired antenna) to the base station, which may subsequently instruct the terminal to execute a handover to a particular channel based on the reported measurements.

It will be appreciated that a desired antenna may be determined in a number of different ways. For example, in some embodiments, determination of a desired antenna may involve identifying a desired antenna/channel combination, and identifying the antenna component of this combination as the desired antenna. In some embodiments, however, a desired antenna may be the antenna that, in an aggregate sense over a plurality of channels, produces the best performance. In further embodiments, identification of a desired antenna may be made dependent on identifying a best channel. For example, a best channel may be identified (by the terminal or the base station) based on consideration of measurements over all the possible antennas. Such a best channel may, for example, represent a handover candidate that the base station is likely to select for handover of the terminal. Identification of a desired antenna may be based on the identified best channel, e.g., the desired antenna may be the antenna that provides the best performance given the selected best channel. It will be appreciated that other variations of such operations may be used in some embodiments of the present invention, for example, selection techniques based on a priori knowledge of which channel is more likely to be commanded for handover by the base station, or selection techniques that are biased based on predictions of the future signal propagation environment of the terminal.

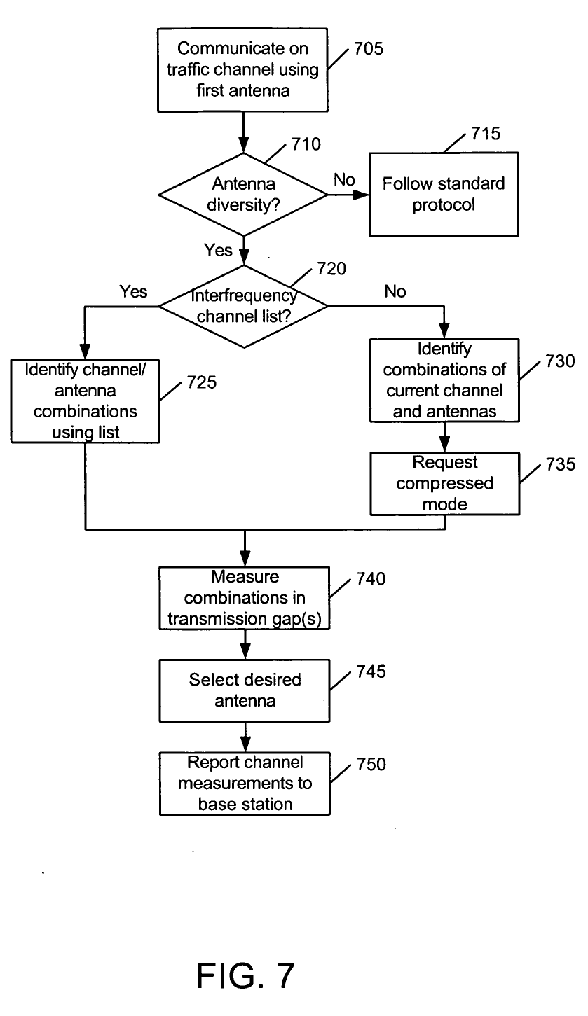

FIG. 7 illustrates exemplary operations according to further embodiments of the present invention. A wireless terminal having a plurality of selectable diverse antenna paths communicates with a base station over a traffic channel using a first antenna (block 705). If antenna diversity is disabled in the terminal (block 710), a standard compressed mode channel measurement protocol may be followed (block 715). If antenna diversity is enabled (block 710), however, the terminal may determine whether an interfrequency search list currently exists (block 720). For example, the terminal may already be in a base station initiated compressed mode, and may have already been provided with a list of handover candidate channels for which the base station has requested measurements.

If such a list is present, the terminal may identify a plurality of combinations of these channels (and its current traffic channel) and its various antennas (block 725). If not, for example, if the terminal is not currently in compressed mode, the terminal may identify a plurality of combinations of its current traffic channel and it various antennas (block 730), and request terminal initiated compressed mode operation (block 735). The terminal may then measure the various identified antenna/channel combinations in one or more transmission gaps in compressed mode (block 740). Responsive to these measurements, the terminal may select a desired antenna (block 745), and report channel measurements (e.g., channel measurements using the desired antenna) to the base station.

It will be understood that the operations described in the figures are illustrative examples of some embodiments of the invention, and that variations of such operations fall within the scope of the present invention. Generally, the flowchart and schematic diagrams described above illustrate architecture, functionality, and operations of some embodiments of the present invention, and each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

The present invention may be embodied as methods, systems (apparatus), and computer program products. Accordingly, the present invention may be embodied in hardware, software or combinations thereof. Furthermore, the present invention may take the form of a computer program product on a computer-usable storage medium having computer-usable program code embodied in the medium. Applicable storage media include, but are not limited to, hard disks, CD-ROMs, optical storage devices and magnetic storage devices. Such a computer program product may be configured to execute in a data processing device, such as the control processor 130 of FIG. 1.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language and/or a lower level assembler language. The program code may execute entirely on the user's computer (i.e., controller of the user's mobile terminal), partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Furthermore, the present invention has been described in part above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method of operating a wireless terminal, the method comprising:
establishing a communications session between the wireless terminal and a base station; and
measuring reception of at least one channel over respective selection diverse reception paths in the wireless terminal during at least one transmission gap in the communications session.

2. The method of claim 1, wherein the at least one transmission gap comprises a handover candidate channel evaluation transmission gap and/or an interfrequency measurement gap.

3. The method of claim 1, wherein measuring reception of at least one channel over respective selection diverse reception paths in the wireless terminal during at least one transmission gap in the communications session is preceded by transitioning to a compressed mode of communications between the base station and the terminal, and wherein the at least one transmission gap comprises a transmission gap associated with the compressed mode.

4. The method of claim 1, wherein measuring reception of at least one channel over respective selection diverse reception paths in the wireless terminal during at least one transmission gap in the communications session comprises measuring reception of the at least one channel via first and second antennas of the wireless terminal.

5. The method of claim 4, wherein measuring reception of at least one channel over respective selection diverse reception paths in the wireless terminal during at least one transmission gap in the communications session is preceded by transitioning to a compressed mode of communications between the base station and the terminal, and wherein the at least one transmission gap comprises a transmission gap associated with the compressed mode.

6. The method of claim 4, wherein measuring reception via first and second antennas of the wireless terminal comprises measuring reception via the first and second antennas for a plurality of handover candidate channels.

7. The method of claim 6, further comprising reporting measurements of the handover candidate channels to the base station.

8. The method of claim 6, wherein measuring reception via the first and second antennas for a plurality of candidate channels is preceded by the base station identifying the plurality of handover candidate channels to the wireless terminal.

9. The method of claim 4, further comprising selecting one of the first and second antennas for communications of the wireless terminal responsive to measuring reception via the first and second antennas of the wireless terminal.

10. A wireless terminal comprising:
a radio reception system configured to provide selection diverse first and second reception paths in the wireless terminal; and
a controller operatively associated with the reception system and configured to measure reception of at least one channel over the respective selection diverse first and second reception paths during at least one transmission gap in a communications session between the wireless terminal and a base station.

11. The terminal of claim 10, wherein the at least one transmission gap comprises a handover candidate channel evaluation transmission gap and/or an interfrequency measurement gap.

12. The terminal of claim 10, wherein the at least one transmission gap comprises a transmission gap associated with a compressed mode of communications.

13. The terminal of claim 10:
wherein the reception system comprises first and second spatially separate antennas and a receiver configured to selectively receive signals via the first and second antennas; and
wherein the controller is configured to measure reception via the first and second antennas during the at least one transmission gap.

14. The terminal of claim 13, wherein the at least one transmission gap comprises a transmission gap associated with a compressed mode of communications.

15. The terminal of claim 13, wherein the controller is configured to measure reception via the first and second antennas for a plurality of candidate channels.

16. The terminal of claim 15, wherein the controller is further configured to report measurements of the candidate channels to the base station via a radio transmission system of the wireless terminal.

17. The terminal of claim 13, wherein the controller is further configured to select one of the first and second antennas for communications of the wireless terminal responsive to measuring reception via the first and second antennas of the wireless terminal.

18. A computer program product for controlling a wireless terminal, the computer program product comprising computer program code embodied in a storage medium, the computer program code comprising:
program code configured to establish a communications session between the wireless terminal and a base station and to measure reception of at least one channel over respective selection diverse reception paths in the wireless terminal during at least one transmission gap in the communications session.

19. The computer program product of claim 18, wherein the at least one transmission gap comprises a handover candidate channel evaluation transmission gap and/or an interfrequency measurement gap.

20. The computer program product of claim 18, wherein the at least one transmission gap comprises a transmission gap associated with a compressed mode of communications between the wireless terminal and a base station.

21. The computer program product of claim 18, wherein the selection diverse reception paths comprise first and second antennas of the wireless terminal.

22. The computer program product of claim 18, wherein the computer program code further comprises program code configured to select one of the first and second antennas for communications of the wireless terminal responsive to measuring reception via the first and second antennas of the wireless terminal.
